(19) United States
(12) Patent Application Publication
(10) Pub. No.: US 2002/0158240 A1
(43) Pub. Date: Oct. 31, 2002

(54) Speed varying device intended for use in combination with a winch for nautical use

(75) Inventors: Andrea Merello, Genova (IT); Luciano Bonassi, Saronno (IT); Alberto Lozza, Cornaredo (IT)

Correspondence Address: Russell W. Pyle, Suite 850, 221 N. LaSalle Street, Chicago, IL, 60601, US

(73) Assignee: Harken Italy S.p.A

(21) Appl. No.: 10/101,766

(22) Filed: Mar. 18, 2002

(30) Foreign Application Priority Data
Mar. 21, 2001 (IT) M12001A000595

(51) Int. Cl. B66D 1/14

(52) U.S. Cl. 254/294

(57) ABSTRACT

The device has an input shaft intended to be connected to motor members and rotating at an input speed and an output shaft intended to be connected to the winch and rotating at an output speed, the ratio between the output speed and the input speed being equal to a transmission ratio. The device provides a first operation mode, in which:

when the input shaft rotates in its first direction of rotation, the output shaft rotates in its first direction of rotation, with a first transmission ratio; and

when the input shaft rotates in its second direction of rotation which is opposite to that of the first, the output shaft rotates in its second direction of rotation which is opposite to the first, with a second transmission ratio.

### DESCRIPTION

The present invention regards the field of on-board equipments for manoeuvring a sail boat, in particular for manoeuvring sailing sheets in high performance competition yachts.

Yacht's sheets are usually actuated through winches. A winch is made to rotate by motor means, typically pedestals equipped with handles (actuated by one or two particularly strong sailors) kinematically connected to an input shaft of the winch, and transfers a traction force by friction to the sheets which are partially wound on the winch drum. For a more efficient action, multi-speed (or multi-gear, the two terms being used in an interchangeable manner) winches, i.e. which allow the ratio between the rotation speed imparted by the motor means to the input shaft and the rotation speed of the drum to be varied, have been known and widely used for some time. In this way, it is possible to use a longer ratio for a rapid recovery of the sheet with small traction forces and a shorter ratio to apply a more intense traction during sail adjustment stage.

Two-speed winches normally provide that a first ratio be in operation when the actuation of the input shaft takes place in one direction, and that the second ratio be in operation when the actuation takes place in the opposite direction. The change in ratio is thus obtained by simply changing the actuation direction of the input shaft. It should be noted that the direction of rotation of the drum upon which the sheet is wound always remains the same, any rotation in the opposite direction being prevented. Winches of this type allow the provision of a long ratio (or a high speed) for sheet recovery operations, and a short ratio (or a low speed) for adjustment operations of the sails under a load.

Therefore, they are satisfactory in many applications.

In reality, not all of the adjustment operations require the same type of force, typically in down-wind sailing lesser forces and larger displacements are required with respect to close-hauling.

In order to put sailors in better conditions for each specific sailing manoeuvre, three-speed winches have thus been developed. The changing from one ratio to another basically always takes place through a change in the direction of rotation. Since in typical use during a sailing manoeuvre a sequence of ratios is usually required from a longer one to an intermediate one to a shorter one, the winch is initially set inserting a gear (by pressing a button) so that a long ratio is initially available; upon the first inversion of the actuation rotation, it passes to an intermediate ratio whilst the gear disengages automatically; upon the second inversion of the actuation rotation, it finally passes to a short ratio.

Usually, the three ratios are all used in close-hauling, whereas in down-wind sailing the two longer ratios are sufficient; to prevent the passing to the short ratio, the button for actuating the gear has a lock position which prevents the disengagement of the gear.

In the most hard-fought competitions, where it is necessary to exploit every last inch out of the crew to guarantee even the tiniest advantage over the opponent, even three-speed winches are insufficient. Indeed, whilst the longer ratio appears suitable for the fast recovery of the sheets in whatever point of sailing, in the sail adjustment stages both of the shorter ratios which are useful for close-hauling seem to be too short for down-wind sailing, where a fourth ratio would be better instead, somewhere between the long ratio and the ratio referred to above as intermediate.

Therefore, winches with more than three speeds have been developed; see for example patent U.S. Pat. No. 4,667,934. However, these are devices which are mechanically very complex (and thus heavy and expensive) and which are rather hard to use.

Therefore, the requirement on board a yacht to have the possibility of actuating the sails with four different speeds, in a manner which is easy to use, has still not been fully satisfied.

The idea at the base of the present invention is that of using a normal three-speed winch combined with a speed-varying device.

At the base of such an idea, the present invention therefore regards a speed-varying device according to claim 1.

Such a device allows the winch to be sized according to close-hauling requirements, and allows the use of the change in ratio due to the inversion in rotation for down-wind sailing.

Further characteristics and advantages of a speed varying device according to the invention shall become clearer from the following detailed description of a preferred embodiment thereof, given with reference to the attached drawings. In such drawings:

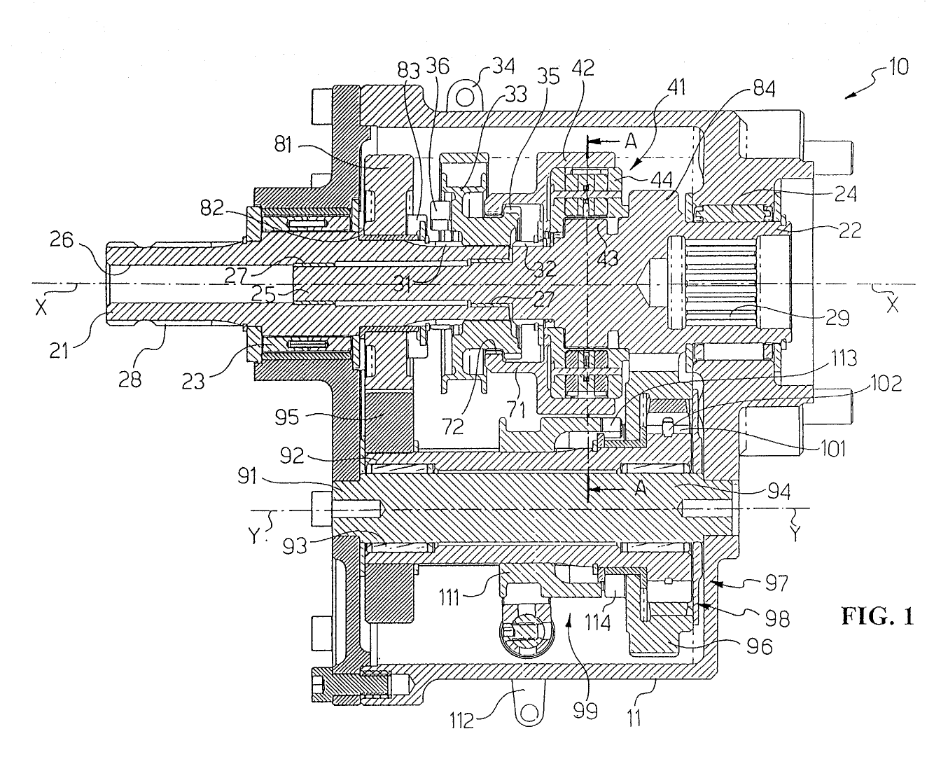

FIG. 1 is a side section view of a varying device according to the invention;

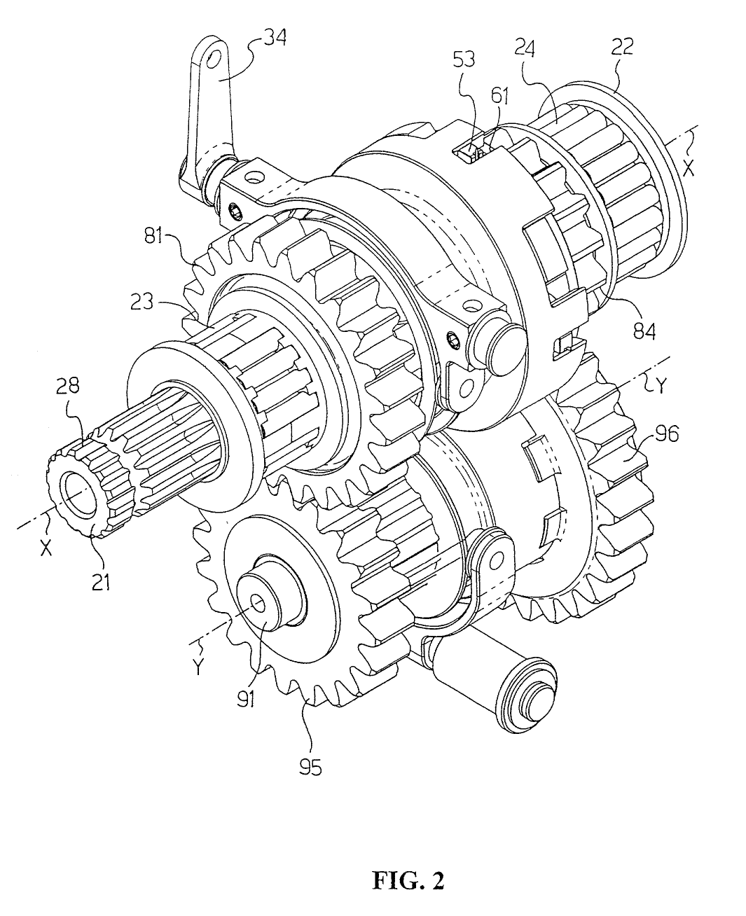

FIG. 2 is a three-quarters front perspective view of the inner members of the device of FIG. 1;

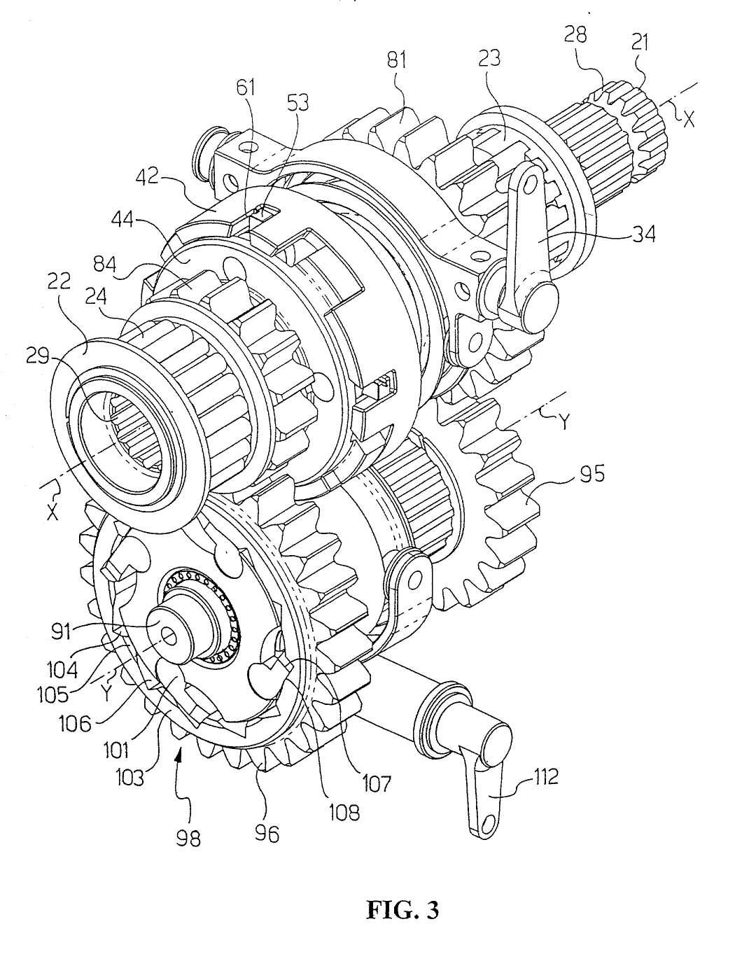

FIG. 3 is a three-quarters rear view of the inner members of the device of FIG. 1;

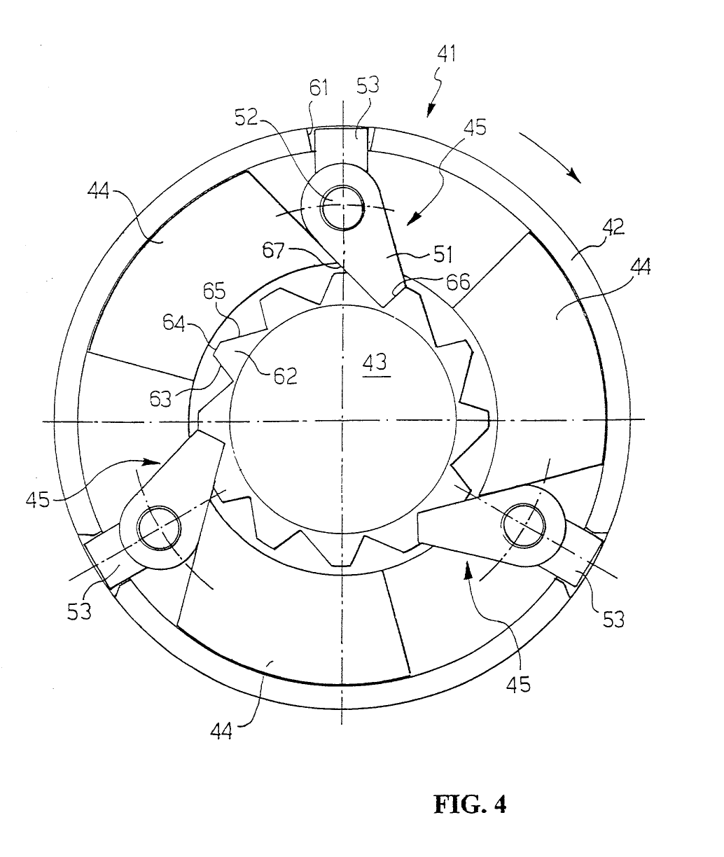

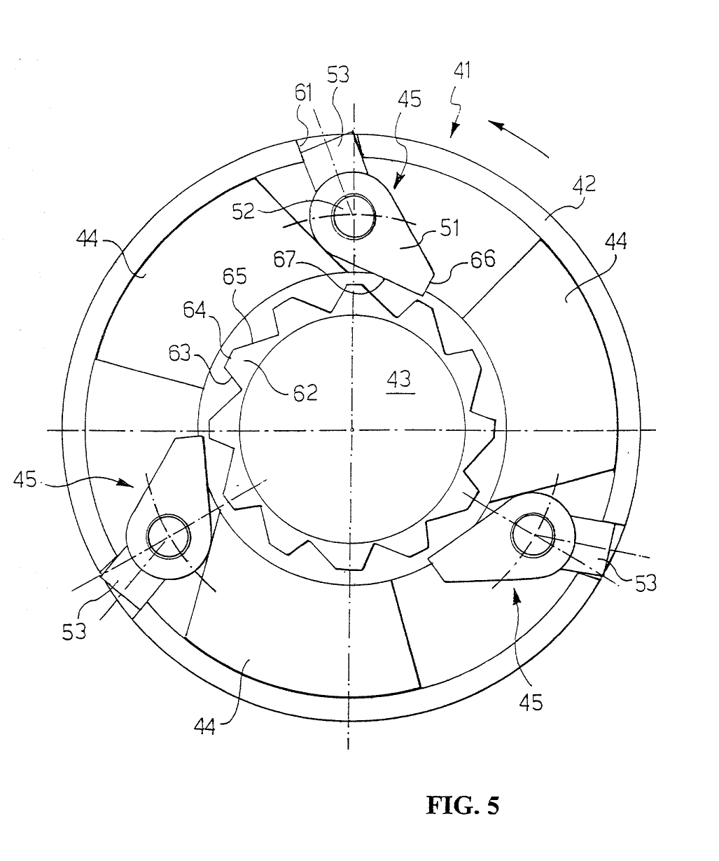

FIGS. 4 and 5 are cross section views taken according to the line A-A, schematized and simplified to show two operating conditions of a detail of the device of FIG. 1;

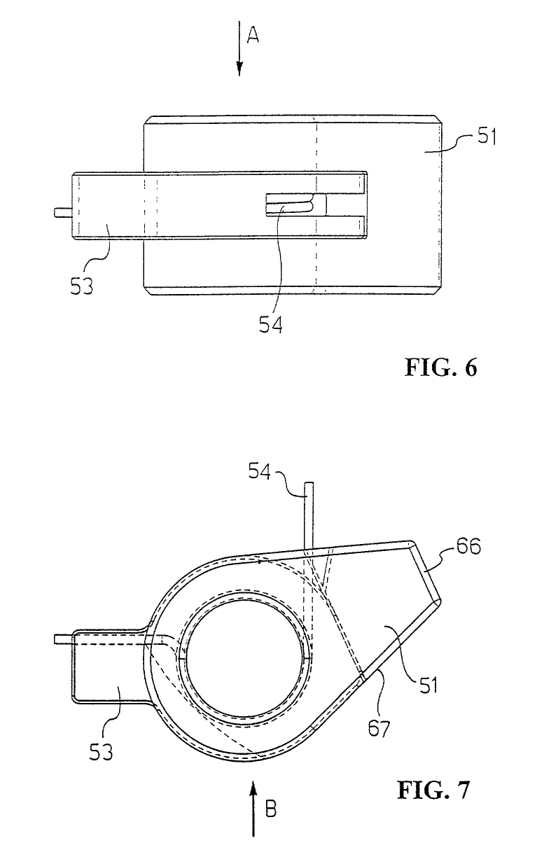

FIG. 6 is a view of a detail of the device of FIG. 1, taken according to the direction B;

FIG. 7 is a view of the same detail as in FIG. 6, taken according to the direction C;

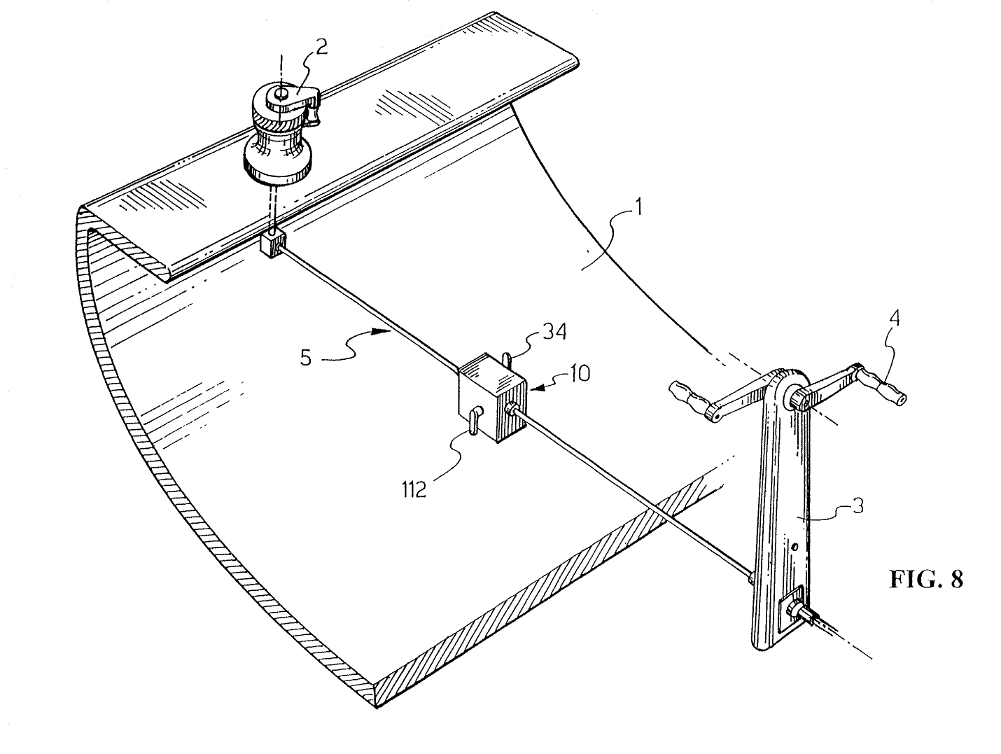

FIG. 8 is a sketch showing the use of the device of FIG. 1 on board a yacht;

In the figures, in particular in FIG. 8, a yacht 1 is shown with a winch 2 and a pedestal 3 for actuating the winch 2, equipped with handles 4 for manual actuation by one or two sailors. Between the pedestal 3 and the winch 2 a mechanical transmission is provided, generally indicated with 5, which comprises a speed varying device according to the invention generally indicated with 10.

With particular reference to FIG. 1, the device 10 comprises an outer crankcase 11 in which all of the members of the device itself 10 are housed, arranged mainly for rotation about two coplanar and parallel axes, a primary axis X and a secondary axis Y.

Aligned on the primary axis X, an input shaft 21 and an output shaft 22 are provided, supported rotatably by the crankcase 11 through rolling bearings 23 and 24, respectively; the two shafts 21 and 22 are then coupled rotatably with each other, through a pivot 25 of the shaft 22 which engages in a hole 26 of the shaft 21, with the interposition of bearings 27. Both of the shafts 21 and 22 are equipped with drive coupling means for inserting into the transmission gear 5: the input shaft 21 has a grooved outer profile 28 whereas the shaft 22 has a grooved inner profile 29.

The interfacing portions of the two shafts 21 and 22 are equipped with respective outer grooved profiles 31 and 32 having the same characteristics, even if they have a different axial extension. On the profile 31 of the shaft 21, which has a greater axial extension than the profile 32, a grooved sleeve 33 is fitted which has an axial extension no greater than that of the profile 31 but which is sufficient to engage with both of the profiles 31 and 32 simultaneously. Indeed, the sleeve 33 is capable of sliding axially upon the command of a lever mechanism 34, so as to be able to take up an idle intermediate position (the one represented in FIG. 1), a first operating position in which it straddles the two profiles 31 and 32 (sleeve 33 displaced to the right, with respect to what is illustrated in FIG. 1) and a second operating position completely inset on the profile 31 (sleeve 33 displaced to the left, with respect to what is represented in FIG. 1). The sleeve 33 is then equipped with an outer grooved profile 35 and a front toothing 36.

On the output shaft 22, in a position adjacent to the grooved profile 32, a releasable free wheel mechanism 41 is mounted. With the term free wheel mechanism (or free wheel) it is meant to indicate (in the whole of the present patent specification) a mechanical coupling device between two rotating elements, such that if one of the two rotating elements rotates in one direction of rotation with respect to the other, the one pulls the other, whereas if the one rotates in the opposite direction, the one does not pull the other; with the term releasable free wheel mechanism (or releasable free wheel) it is meant to indicate (in the whole of the present patent specification) a free wheel in which means for preventing pulling in both directions are provided; with the term lockable free wheel mechanism (or lockable free wheel) we mean to indicate (in the whole of the present patent specification) a free wheel in which means for allowing pulling in both directions are provided.

The releasable free wheel 41 comprises three rotors which are concentric with each other and with the axis X: an outer primary rotor 42, an inner secondary rotor 43 (formed from a section 22 of the output shaft itself) and an auxiliary rotor interposed between the two rotors 42 and 43. The auxiliary rotor 44 is equipped with a plurality of unidirectional engagement members, wholly indicated with 45. It should be noted that in FIGS. 4 and 5 only three members 45 are represented for ease of drawing, whereas their number shall obviously be greater.

The auxiliary rotor 44 is capable of freely rotating on the secondary rotor 43, whereas it can rotate but with friction inside the primary rotor 42. The unidirectional engagement members 45 each comprise a pawl 51 mounted on the auxiliary rotor 44 by means of a pivot 52 directed parallel to the axis X, a release lever 53 mounted on the same pivot 52, and a spring 54 acting between the pawl 51 and the lever 53; the pawl 51 and the lever 53 are shaped and coupled so that the lever 53 constitutes a mobile stop for the pawl 51, whereas the spring 54 tends to ensure that the pawl 51 is arranged with respect to the lever 53 in the end-of-stroke position.

Each lever 53 faces and is engaged in a respective window 61 of the primary rotor 42. Each pawl 51 is engaged with a plurality of teeth 62 formed on the secondary rotor 43; in particular, each tooth 62 comprises a pushing side 63, a ridge 64 and a sliding side 65, whereas every pawl 51 comprises a pushing head 66 and a sliding side 67.

The releasable free wheel 41 then comprises a crown 71 with an inner grooved profile 72, complementary to the grooved profile 35 formed on the sleeve 33 and arranged axially on the axis X so that the two grooved profiles 35 and 72 engage with each other when the sleeve 33 is in its second operating position (the one displaced to the left, with reference to FIG. 1).

On the input shaft 21, in a position adjacent to the grooved profile 31, a sprocket 81 is fitted idly, with the interposition of a bearing 82. The wheel 81 is then equipped with a front toothing 83, arranged opposite and complementary to the front toothing 36 of the sleeve 33. The axial position of the two front toothings 36 and 83 is such that they are engaged when the sleeve 33 is in its second operating position (the one displaced to the left, with reference to FIG. 1).

On the output shaft 22, in a position adjacent to the releasable free wheel 41, a sprocket 84 is formed (or possibly fitted so as to be integral in rotation).

The device 10 then comprises a pivot 91, mounted in the crankcase 11 along the secondary axis Y, upon such a pivot being idly mounted an auxiliary shaft 92, with the interposition of bearings 93 and 94. A sprocket 95 is fitted integral in rotation on the shaft 92, engaged with the sprocket 81. A further sprocket 96, engaged with the sprocket 84, is mounted on the shaft 92 with the interposition of a lockable free wheel mechanism 97.

More precisely, the free wheel 97 comprises an outer rotor formed from the same sprocket 96, an inner rotor formed from the same shaft 92, a plurality of unidirectional engagement members 98 mounted rotatably on the inner rotor 92, and locking means 99.

The unidirectional engagement members 98 each comprise a pawl 101 mounted rotatably on the inner rotor 92, and a spring 102 acting between the pawl 101 and the inner rotor 92; the spring 102 tends to ensure that the pawl 101 rotates outwards.

Each pawl 101 is engaged with a plurality of teeth 103 formed inside the outer rotor 96; in particular, each tooth 103 comprises a pushing side 104, a ridge 105 and a sliding side 106, whereas each pawl 101 comprises a pushing head 107 and a sliding side 108.

The locking means 99 comprises a sleeve 111 mounted integral in rotation but capable of sliding axially on the shaft 92 (for example through a grooved profile coupling), a lever mechanism 112 for the axial displacement of the sleeve 111, a front toothing 113 on the sleeve 111 and a corresponding front toothing 114 on the wheel 96. Upon the command of the lever mechanism 112, the sleeve 111 can take up a release position (the one illustrated in FIG. 1, with the sleeve 11 displaced to the left) or a locking position (displaced to the right, with reference to FIG. 1); in the locked position, the engagement of the front toothings 113 and 114 make the wheel 96 and the shaft 92 integral in rotation.

The sprockets 81 and 95 have the same number of teeth; on the other hand, the number of teeth of the sprockets 84 and 96 is such that the engagement consisting of such wheels has a transmission ratio equal to about 2:1, i.e. the wheel 96 has double the number of teeth with respect to the wheel 84.

The orientation of the pawls 51 and 101 inside the respective free wheels is that which can be seen from the following description of the operation of the device 10.

Thanks to the structure which has just been described, three different kinds of operation of the device 10 are defined.

A first operation mode is obtained by arranging the lever 34 so that the sleeve 33 is in its second operating position and the lever 112 so that the sleeve 111 is in the release position of the free wheel 97. In these positions, both the sprocket 81 and the outer rotor 42 of the free wheel 41 are integral in rotation with the input shaft 21, whereas the free wheel 97 is not locked.

In this operation mode, if the input shaft 21 rotates in its first direction of rotation, the output shaft 22 rotates in its first direction of rotation (the same as the first direction of rotation of the input shaft 21), with a first transmission ratio, equal to 1:1. Indeed, in this direction of rotation, the transmission of the motion takes place from the input shaft 21, to the sleeve 33 (by means of the grooved profile 31), to the rotor 42 (by means of the grooved profiles 35 and 72), to the rotor 43 (through the unidirectional engagement members 45 of the releasable free wheel 41, see FIG. 4) and then to the shaft 22; in this kinematic chain there is neither a gear-down nor gear-up, for which reason the transmission ratio is equal to 1:1. It should be noted that the transmission of the motion also takes place from the sleeve 33 to the sprocket 81 (by means of the front toothings 36 and 83), to the sprocket 95, and to the secondary shaft 92, but not to the sprocket 96 because the unidirectional engagement members 98 of the free wheel 97 are directed so as to slide and not to pull; actually, the sprocket 96 is moved by the sprocket 84, at a rotation speed which is half of that of the shaft 92, due to the 2:1 ratio between the wheels 84 and 96.

If, on the other hand, the input shaft 21 rotates in its second direction of rotation which is opposite to the first, the output shaft 22 rotates in a second direction of rotation which is opposite to the first, with a second transmission ratio, equal to about 2:1. Indeed, in this direction of rotation, the transmission of the motion takes place from the input shaft 21, to the sleeve 33, to the sprocket 81, to the sprocket 95, to the secondary shaft 92, to the sprocket 96 (by means of the unidirectional engagement members 98, which now pull), to the sprocket 84 and then to the shaft 22. It should be noted that the transmission of the motion also takes place from the sleeve 33 to the rotor 42, but not to the rotor 43; indeed, the reverse rotation of the rotor 42 with respect to before (see FIG. 5) determines a certain initial rotation of the rotor 42 itself with respect to the auxiliary rotor 44, with the consequent action of the windows 61 on the levers 53 which displace the end-of-stroke of the respective pawls 51, withdrawing them from any engagement with the teeth 62 of the rotor 43. The transmission from the shaft 21 to the shaft 22 takes place with a transmission ratio of 2:1, determined by the engagement formed by the sprockets 96 and 84. The rotor 43 therefore rotates at twice the speed with respect to that of the rotor 42.

A second operation mode is obtained by displacing the lever 34 so that the sleeve 33 displaces and engages with both of the grooved profiles 31 and 32, still with the lever 112 in a position such as not to lock the free wheel 97. In this case, the transmission is directed between the two shafts 21 and 22, with a 1:1 ratio in both directions of rotation. The sleeve 33 also rotates with the shafts 21 and 22, but does not engage and therefore does not actuate either the sprocket 81 or the rotor 42.

A third operation mode, on the other hand, is obtained by displacing the lever 34 as in the first operation mode, and by displacing the lever 112 so as to lock the free wheel 97. In this case, the transmission of the motion takes place anyway through the secondary shaft 92, with a transmission ratio equal to 1:2, in both directions of rotation. The releasable free wheel 41 is not an obstacle precisely because it is releasable; indeed, once the release is obtained as shown in FIG. 5, the subsequent locking can only be obtained if the outer rotor 42 rotates faster than the auxiliary rotor 44. This is something which cannot take place if the locking of the free wheel 97 maintains a transmission ratio of 2:1.

Now focussing on the use in sailing, one can consider using a winch 2 with three ratios suitable for close-hauling, for example 1:1 (long ratio) 1:10 (short ratio), 1:40 (ultra-short ratio). The long ratio will be useful in the first recovery stage of the sheet after tacking, the short ratio will be useful for a first summary adjustment of the sail and the very short ratio will be useful for the fine adjustment of the sail.

By considering having a 2:1 gear-up upstream of the winch, the three ratios shall theoretically be modified thus: 2:1 (very long ratio), 1:5 (medium ratio), 1:20 (very short ratio).

Experience in sailing shows that in down-wind sailing the two useful ratios are the long one (1:1) and the medium one (1:5).

It is, therefore, possible to advantageously use the device of the invention as follows.

In close-hauling, the second operation mode of the device shall be used, which provides a 1:1 transmission in both directions of rotation and therefore allows the three winch ratios (long, short and ultra-short) to be used directly.

In down-wind sailing, on the other hand, the first operation mode of the device of the invention can be used, at the same time locking the winch mechanism to exclude the shortest ratio. Thanks to the special features of the first operation mode (1:1 ratio in one direction and 2:1 ratio in the other direction), overall an operation with a long ratio (1:1) in one direction, and medium ratio (1:5) in the other direction will be obtained, just as is sought after with such points of sailing.

However, the characteristics of the device of the invention allow further beneficial uses in special racing conditions.

Indeed, with the third operation mode applied to the same winch shown as an example above, a very long ratio (2:1) is obtained which is particularly advantageous in gybing of the gennaker, in which the length of sheet to be recovered is very long. In this case, the shortest ratios which can be obtained from the changing in ratio on the winch are of no use.

Moreover, by using the first operation mode without however locking the winch mechanism to exclude the shortest ratio, the sequence of long (1:1), medium (1:5), ultra-short (1:40) ratios is obtained. It has been noted that these ratios are very useful in the so-called pre-start stage, in which the boats prepare for the start of the yacht race trying to put themselves in the best conditions; it is a stage in which manoeuvres of all types must be carried out in rapid sequence, and the three aforementioned ratios seem to give greater flexibility and therefore an advantage.

The device of the invention, of which a preferred embodiment has been described, is nevertheless susceptible to numerous modifications.

In particular, the releasable free wheel could be realised in different manners to those illustrated, for example by employing two axially distinct sections which can be rotated with respect to each other as teeth upon which the pawls push; the exclusion from engagement (i.e. the release) could thus be obtained with a total dephasing of the teeth between the two sections, such that the pawls (the axial extension of which would in any case encompass both of the sections) would no longer find the side against which to rest for the pulling engagement.

Another possibility would be to provide closable windows on the inner edge of the auxiliary rotor, through which the pawls interface.

In the choice amongst these alternatives and others which can be specified by the man skilled in the art it must, however, be kept in mind that for the correct operation of the invention it is necessary that the body of the releasable free wheel mechanism upon which one acts for the release is the first to receive the motion from the input shaft, so that the start of rotation determines the establishment and the cancelling of the release.

As for the indicated transmission ratios, they were only given as an example. Even the 1:1 ratio is not necessarily compulsory, since it is easy to provide gear-downs and gear-ups with simple engagements if it is thought necessary.

In the same way, it is not necessary that the input and output shafts be coaxial and aligned, nor that they rotate harmoniously. It is, however, necessary for a correct use together with traditional three-speed winches, that to one direction of rotation of the input shaft always corresponds the same direction of rotation of the output shaft.

1. Speed varying device intended for use in combination with a winch for nautical use, having an input shaft intended to be connected to drive members and rotating at an input speed and an output shaft intended to be connected to the winch and rotating at an output speed, the ratio between the output speed and the input speed being equal to a transmission ratio, characterised in that a first operation mode is provided, in which:
when the input shaft rotates in its first direction of rotation, the output shaft rotates in its first direction of rotation, with a first transmission ratio; and
when the input shaft rotates in its second direction of rotation which is opposite to that of the first, the output shaft rotates in its second direction of rotation which is opposite to the first, with a second transmission ratio.

2. Device according to claim 1, in which a second operation mode is provided, in which:
when the input shaft rotates in its first direction of rotation, the output shaft rotates in its first direction of rotation, with its first transmission ratio; and
when the input shaft rotates in its second direction of rotation, the output shaft rotates in its second direction of rotation, with its first transmission ratio.

3. Device according to claim 1 or 2, in which a third operation mode is provided, in which:
when the input shaft rotates in its first direction of rotation, the output shaft rotates in its first direction of rotation, with its second transmission ratio; and
when the input shaft rotates in its second direction of rotation, the output shaft rotates in its second direction of rotation, with its second transmission ratio.

4. Device according to any one of claims 1 to 3, in which the second transmission ratio is different from the first.

5. Device according to claim 4, in which the second transmission ratio is about half the first transmission ratio.

6. Device according to claim 5, in which the first transmission ratio is about 1:1 and the second transmission ratio is about 1:2.

7. Device according to claim 1, comprising two parallel kinematic routes between the input shaft and the output shaft, the first route comprising a releasable free wheel and having the first transmission ratio, the second route comprising a free wheel and having the second transmission ratio.

8. Device according to claim 7, in which the releasable free wheel comprises:
an outer primary rotor,
an inner secondary rotor, concentric with the primary rotor,
an auxiliary rotor interposed between the primary rotor and the secondary rotor,
a plurality of unidirectional engagement members rotatably supported by the auxiliary rotor and capable of engaging on teeth formed in the secondary rotor,
spring means for pushing the engagement members towards an engagement position with the teeth of the secondary rotor,
release means for holding the unidirectional engagement members away from the engagement position.

9. Device according to claim 8, in which:
the engagement members each comprise a pawl equipped with a pushing head for the pulling engagement on corresponding pushing sides of the teeth of the secondary rotor in one direction of rotation, and with a sliding side for the sliding engagement on the teeth of the secondary rotor in the opposite direction of rotation;
the release means for each pawl comprise an actuation lever rotatably mounted coaxial to the pawl itself, and a command window formed in the primary rotor and engaged with the command lever.

10. Device according to claims 2 and 7, comprising a third bi-directional kinematic route, alternative to the first two and with the first transmission ratio, and means for selectively actuating the third or else the first two kinematic routes.

11. Device according to claims 3 and 7, comprising means for locking the free wheel.
